(19) United States
(12) Patent Application Publication
(10) Pub. No.: US 2003/0098277 A1
(43) Pub. Date: May 29, 2003

(54) Sweetening of mixed liquor during solid-liquid separation

(76) Inventor: Boris M. Khudenko, Atlanta, GA (US)

Correspondence Address: Boris M. Khudenko, 744 Moores Mill Rd., Atlanta, GA, 30327, US

(21) Appl. No.: 09/994,308

(22) Filed: Nov. 24, 2001

(51) Int. Cl. C02F 3/00

(52) U.S. Cl. 210/601

(57) ABSTRACT

This is an improved method of separation of biomass and treated wastewater after biological processes conducted with flocculent or granular sludge forming mixed liquor, wherein a step of stripping carbon dioxide formed due to degrading of stored organics and/or sludge degradation is provided thus reducing or eliminating the potential for forming microscopic bubbles of carbon dioxide in sludge particles and improving their settling. The process is further improved by providing in the mixed liquor recuperable alkaline ions, preferably calcium, which provides additional alkalinity reserve in form of calcium carbonate. Small additions of alkali metal ions further improves the process. Other advantages of the method include improved heavy metals and TDS removal, reduction in the secondary emissions of BOD, COD, and ammonia, and oxygen saturation of the treated wastewater.

### FIELD OF INVENTION

The present method belongs to chemical and physical-chemical improvements during sludge separation steps in a broad class of biological wastewater treatment processes, particularly, in the following: better separating sludge and reduced solids contents in the effluent, removal of minerals including total dissolved solids and heavy metals, reduction in secondary BOD, COD, and ammonia emissions and thus in lower BOD, COD, and ammonia in the treated wastewater, increasing the alkalinity reserve, and saturating the effluent with oxygen prior to the wastewater discharge.

### PRIOR ART

In biological systems, such as aerobic with air or oxygen, anoxic, facultative, acidogenic or acetogenic, and anaerobic methanogenic, a flock forming or a granular sludge forming biomass is used in the biological steps of conversion of organics. In most biological systems biomass is separated from the treated wastewater in gravity separation steps which usually are conducted in clarifiers or settling tanks, fluidized beds or suspended sludge blanket clarifiers, and combinations of these gravity separators. Gravity separation is well established. It is simple and inexpensive. Various modifications of gravity separation devices have been developed for a broad range of conditions, from small to large flows, from low biomass concentrations such as in activated sludge process (less than 1 g/L to 10 g/L) to high biomass concentration such as in some anaerobic reactors (about 100 g/L). Nonetheless, gravity separators quite often fail to separate solids from liquid efficiently. While many causes of poor separation have been discussed, the most important one is carbon dioxide production in the flock (or granule) which makes the flock (or granule) floating and poorly settling. Flocks and granules of biomass are similar in the respects discussed here, accordingly, it is understood that these terms can be used in this specification interchangeably. Formation of carbon dioxide in flocks may account for many sludge separation problems as a root cause of problems for which other reasons may have been stated.

Carbon dioxide in biological flocks is formed due to continuing conversion of organics taken up and stored by biomass and/or due to the organics recycle in biomass “die off”-“lysis”-“emission of secondary organics”-“consumption of secondary organics” by the surviving species in the flock. This cycle can be called sludge autodegradation. Accordingly, carbon dioxide is continuously formed in the flock regardless of the degree of wastewater treatment. The rate of generation of carbon dioxide may be greater in high rate, lower efficiency processes than in low rate processes. However, sludge autodegradation occurs to a lesser or greater degree even in long age sludges in low rate processes. In well mixed reactor environment, carbon dioxide is produced in flocks and significantly diffuses outside, if the concentration gradient is favorable, for example, in air aerated activated sludge process. In most anaerobic and oxygen-based aerobic processes the concentration gradient is not sufficient. In clarifiers and settling tanks mixing is insignificant and the concentration gradient of carbon dioxide inside and immediately outside flocks, especially in a settled or substantially settled conditions, is small. Accordingly, carbon dioxide concentration within flocks increases, thus leading to pH drop, which in turn causes the formation of free carbon dioxide and, eventually, gaseous carbon dioxide inside in form of microscopic bubbles in the flocks. Gas saturated flocks tend to float up instead of settling. The sludge volume index (SVI) of such sludge increases. These conditions are often exacerbated in clarifiers and settling tanks producing dense sludge, which requires longer sludge holding time in the separation devices.

In addition to poor settling, acidification of the environments inside and outside the flock causes dissolution of heavy metals otherwise precipitated as carbonates and hydroxides. Total dissolved solids (TDS) also increase due to dissolution of heavy metal and other salts, for example, calcium carbonate. Alkalinity reserves of separated wastewater effluent and sludge decrease. Concentration of oxygen drops with the concurrent emission of secondary BOD, COD, and ammonia.

The objective of the present invention is to provide a method with significant reduction in the formation of free and gaseous carbon dioxide in the biomass being separated from mixed liquor.

It is also the objective of the present invention to reduce SVI and increase the rate of sludge separation by gravity.

Another objective is to provide a simple and inexpensive method of reducing concentrations of heavy metals and TDS in the treated effluent and simultaneously increasing alkalinity of separated sludge and wastewater effluent.

A further objective of the present invention is to reduce secondary emissions of BOD, COD, and ammonia during solid-liquid separation.

Yet another objective of the present invention is to saturate the treated effluent with oxygen.

Other objectives of the present invention will become apparent from the ensuing description.

### SUMMARY OF THE INVENTION

This is a method of separation of biomass and treated wastewater after biological processes. Biomass and treated wastewater form mixed liquor and after separation become separated biomass and separated treated wastewater. A new step of stripping carbon dioxide is provided in the course of solid-liquid separation. Liquids and gases with elevated contents of carbon dioxide are often called sour media. Removal of carbon dioxide from such media is called sweetening. Accordingly, the stripping of carbon dioxide in the “biomass”-“treated wastewater” separation processes sweetens the mixed liquor, the separated biomass, and the separated treated wastewater. The benefits of such sweetening for wastewater treatment, and specifically for the solid-liquid separation in biological processes, are described as objectives of the present invention. Biological treatment can be oxygen-based aerobic treatment, air based aerobic treatment, anoxic treatment, sulfur reducing anaerobic treatment, ferric ions reducing anaerobic treatment, acidogenic anaerobic treatment, acetogenic anaerobic treatment, methanogenic anaerobic treatment, ferrous ions reducing anaerobic treatment, and combinations thereof. The method of separating biomass and treated wastewater can be conducted in separation means such as settling tanks, clarifiers, settling tanks with Imhoff troughs and derivatives of Imhoff designs for example such as used in many anaerobic reactors, settling tanks with upflow of said mixed liquor, settling tanks with horizontal flow of said mixed liquor, settling tanks with a radial flow of said mixed liquor, conical separators, vortex separators, lamellar separators, clarifiers with rigid packing, clarifiers with flexible packing, centrifuges, and combinations thereof.

The step of stripping carbon dioxide can be conducted by air stripping, inert gas stripping, vacuum-stripping, thermal stripping, and combinations thereof. Stripping of carbon dioxide can be improved by providing alkaline species in the mixed liquor. Preferably, recuperable alkaline species should be used. These species are described in the U.S. Pat. No. 5,798,043. This patent is made a part of this specification by inclusion. Most practicable recuperable alkaline species are calcium, iron, and combinations thereof. Recuperable oxidation-reduction species, most preferably, transitional elements, and most preferably, iron can also be used. These species are described in the U.S. Pat. No. 5,919,367. This patent is made a part of this specification by inclusion. Transitional elements can be vanadium, chromium, manganese, iron, cobalt, nickel, and combinations thereof. The recuperable oxidation-reduction species can be fed in forms of zero valence metals, metal salts, inorganic metal-containing compounds, organic metal-containing compounds, and combinations thereof. A step of re-oxidizing the recuperable oxidation-reduction specie can also be provided. The re-oxidizing of recuperable oxidation-reduction species can be conducted with oxidizers such as hydrogen peroxide, hypochlorites, nitrates, oxygen, oxygen of air, ozone, permanganate, and combinations thereof.

The air stripping in the present method can be a continuous stripping with fixed flow rate, on/off stripping, stripping with variable air flow rates, and combinations thereof. Additionally, air stripping can induce mechanical action upon mixed liquor, for example, mixing, rocking, inducing vortex, jolting, and combinations thereof. Air stripping system can include single or multiple air distributors. The operating mode of these multiple distributors can be a simultaneous operation, on/off operation of at least one distributor, variable air flow operation of at least one distributor, and combinations thereof. The separation means for biomass-treated wastewater are provided with air stripping means.

In general, these stripping means can be a low intensity aerator submerged into a clarifier, so that carbon dioxide stripping is effected and a very gentle mixing not disrupting the solids separation is produced. However, in most cases, an enclosure for the air stripping means submerged into the means for separation of biomass and treated wastewater should be provided. Means for circulating mixed liquor and/or biomass being sweetened within the stripping means and between the stripping means and the clarification zone in the separation means can also be provided. Circulating can be induced by such means as inclined baffles, tangential flow deflectors, and combinations thereof.

The separation means can be a rigidly supported separation means, or a floating separation means. Similarly, the stripping means can be a rigidly supported means or a floating means.

### BRIEF DESCRIPTION OF THE DRAWINGS

FIG. 1 is a transverse elevation of a settling trough such as used in Imhoff tanks, the improvement comprises the use of a stripping means built-in the settling trough.

FIG. 2 is a longitudinal elevation of an improved settling trough shown in FIG. 1.

FIG. 3 is a modification of the stripping means built-in the settling trough such as shown in FIG. 1.

FIG. 4 is an elevation of a typical upflow clarifier improved by providing the built-in carbon dioxide stripping means.

FIGS. 5 and 6 are a modification of the stripping means provided in the upflow clarifier of FIG. 4.

FIG. 7 is a longitudinal section of a horizontal flow clarifier with built-in carbon dioxide stripping means.

FIG. 8 is an elevation of a radial flow clarifier with a built-in means for stripping carbon dioxide. FIG. 9 is a plan view of the stripping means shown in FIG. 8.

FIG. 10 is a longitudinal elevation along the central axis line of a lamella clarifier provided with a carbon dioxide stripping means.

FIG. 11 is a layout of a single lamella plate used in the lamella clarifier of FIG. 10.

### DETAILED DESCRIPTION OF EMBODIMENTS

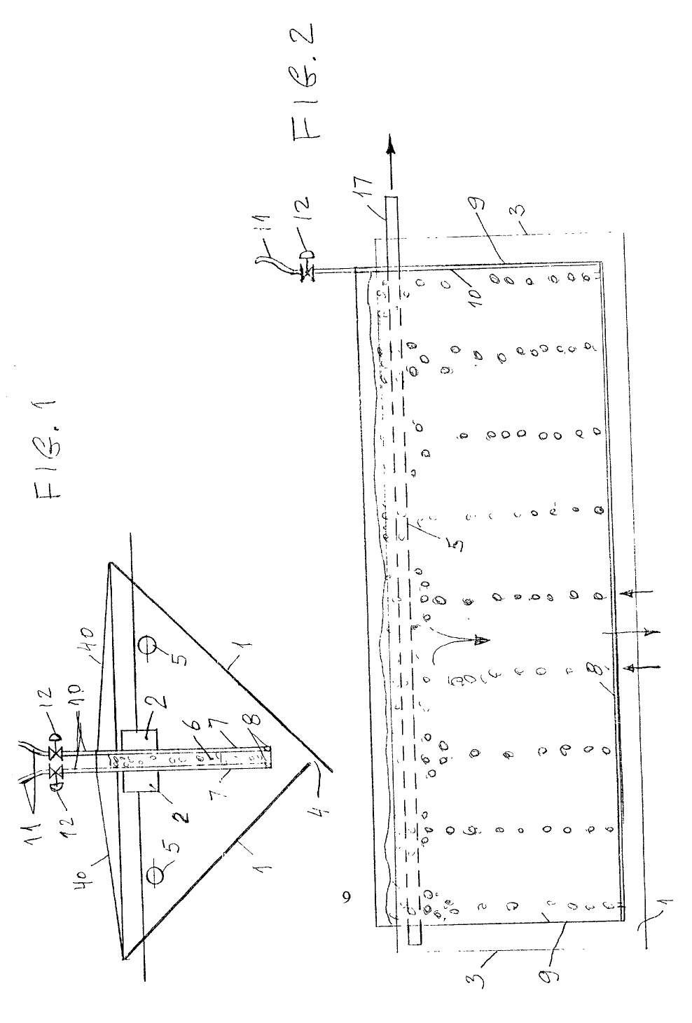

FIGS. 1 and 2 illustrate a very old Imhoff type settling trough. Various modifications of such troughs are still often used, for example, in anaerobic reactors. The trough consists of vertical end walls 3 and inclined side walls 1 forming a slot 4 with the walls overlapping so that gases cannot enter the slot 4 from beneath. As an example, perforated pipes 5 are provided for collecting the clarified effluent. It is known to skilled in art that longitudinal or end troughs can also be used for collecting the clarified wastewater. Pipe 17 is provided for the effluent. A novel element of this settling device is the air stripper 6 formed by side walls 7 and end walls 9. The air stripper is supported in the Imhoff trough by floats 2 and is secured at its horizontal position by mooring lines 40. The air stripper is provided with air distributors 8, air feed lines 10, and optionally automatic or manual valves 12 and flexible tubing 11. It should be noted that the Imhoff trough can be either rigidly fixed in a vessel where a biological process is conducted, or it can be put on floats provided with a flexible tubing 17 and also moored to the vessel.

The embodiment of FIGS. 1 and 2 is operated as follows. Mixed liquor enters the settling trough mainly through the upper part of the slot 4 and flows up towards the collection pipes 5, biomass settles down to the slot 4 and leaves the settling trough predominantly through the lower part of the slot 4. When air is fed uniformly and at a constant flow rate in the stripper via lines 11 and 10 and is distributed by both distributors 8, the incoming mixed liquor is lifted into the air stripper wherein carbon dioxide is stripped. Due to the flow circulations in the air stripper, for example, as shown by arrows, mixed liquor with carbon dioxide at least partially stripped exits the stripper and flows upwardly towards the pipes 5. The separated sludge is settling and exiting the settling trough via slot 4 and the clarified treated wastewater is collected and evacuated by pipes 5 and 17.

During stripping, carbon dioxide is at least partially removed. The equilibrium in “gaseous carbon dioxide”-“free dissolved carbon dioxide”-“bicarbonates”-“carbonates” is shifted from left to right. If the mixed liquor is a calcium-rich liquid and the stripping is efficient, solid calcium carbonate is formed and deposited in the sludge. The quantity of calcium carbonate depends mainly on the available calcium and the amount of carbon dioxide stripped. During stripping, pH increases. The values of pH, dissolved and solid calcium carbonate, bicarbonates, and free dissolved calcium carbonate depend mainly on pH, temperature, total alkalinity, and ionic strength of the solution (or on well correlating value of TDS). As approximate reference points, in a low alkalinity and a low TDS wastewater at 25° C. and pH 8.2 to 8.4 and greater, most carbonic acid species are in form of carbonates and almost all calcium is precipitated. At pH=7, about 20% of carbonic acid species are represented by free carbon dioxide and 80% by bicarbonates. With alkalinity increasing, the precipitation of calcium carbonate shifts to lower pH values and at very substantial alkalinity may occur at pH less than 6 or even 5. Alkalinity can be increased by providing ions of alkaline earth metals. If there is a need to add such ions, preferably calcium should be used. The advantage of the present method is that carbon dioxide is stripped from already treated wastewater (or mixed liquor) wherein the rate of formation of new carbon dioxide is relatively low as compared with biological reactors and the rise in pH occurs much easier than in the biological reactor itself. Accordingly, a lower stripping air requirements are necessary as compared to carbon dioxide stripping associated with pH and alkalinity control in biological reactors. Moreover, pH in the stripped mixed liquor in the settling tanks (or troughs) can rise even above 8.5, which is the commonly accepted upper range for biological processes. If there is enough alkali metal ions in the solution, pH may go up to 9 and higher. Under such conditions, calcium precipitation further improves. Additional feed of a small quantity of alkali metal ions in form of hydroxides, salts of weak acids (carbonic acid or biologically consumable organic acids are preferred), or alkali containing biologically consumable compounds, can easily and inexpensively increase pH in the mixed liquor being sweetened. Achieving pH about 9 is quite possible and inexpensive. Moreover, heavy metals usually present in biologically treated wastewater at low concentrations, such as zinc, copper, cadmium, mercury and other, are also precipitated at elevated pH as carbonates and/or as hydroxides. Concentration of calcium ions in the solution after carbon dioxide stripping is very low and may range from a fraction of one to few milligrams per liter. This small quantity of calcium corresponding to the soluble fraction is lost from the biological system with the effluent from the settling tanks. The bulk of calcium stays in the system because it is retained and recycled with the biomass separated in the biomass-treated wastewater means. Accordingly, calcium is called recuperable alkaline specie. The biomass after stripping and formation of carbonates has no carbon dioxide bubbles inside and is loaded with a relatively heavy mineral deposit of calcium carbonate. Accordingly, such biomass settles faster and has lower SVI.

There are no problems with elevated pH of the returned sludge. Biological processes in such sludge within the clarifiers or settling tanks significantly slow down, thus reducing carbon dioxide production, and reducing emissions of BOD, COD, and ammonia due to the biomass decay. Accordingly, sludge settling properties remain improved due to the removal of carbon dioxide from the flocks and minimizing the production of new carbon dioxide. The effluent quality also improves due to lesser formation of the secondary BOD, COD, and ammonia. On the other hand, the high-pH sludge returned in the biological processes quite rapidly reacts with the biologically generated carbon dioxide with the ensuing conversion of carbonates to bicarbonates and rapid pH drop in the biomass flocks to the usual values for the biological processes.

Alternative operations of the stripping means of FIGS. 1 and 2 can be as follows. Left and right valves 12 operate intermittently. Accordingly, the stripper 6 intermittently swings, or rocks from right to left and back thus producing gentle mixing in the settling means. Such mixing improves sludge coagulation, flock formation, separation, and thickening of the settled sludge. Both valves 12 can be synchronously turned on and off. When the valves are on, the mixed liquor is airlifted in the stripper 6. When both valves are turned off, the mixed liquor drops back in the settling means thus producing a jolt inside the sludge separation zone. Such a jolt is beneficial the same way as the above described mixing.

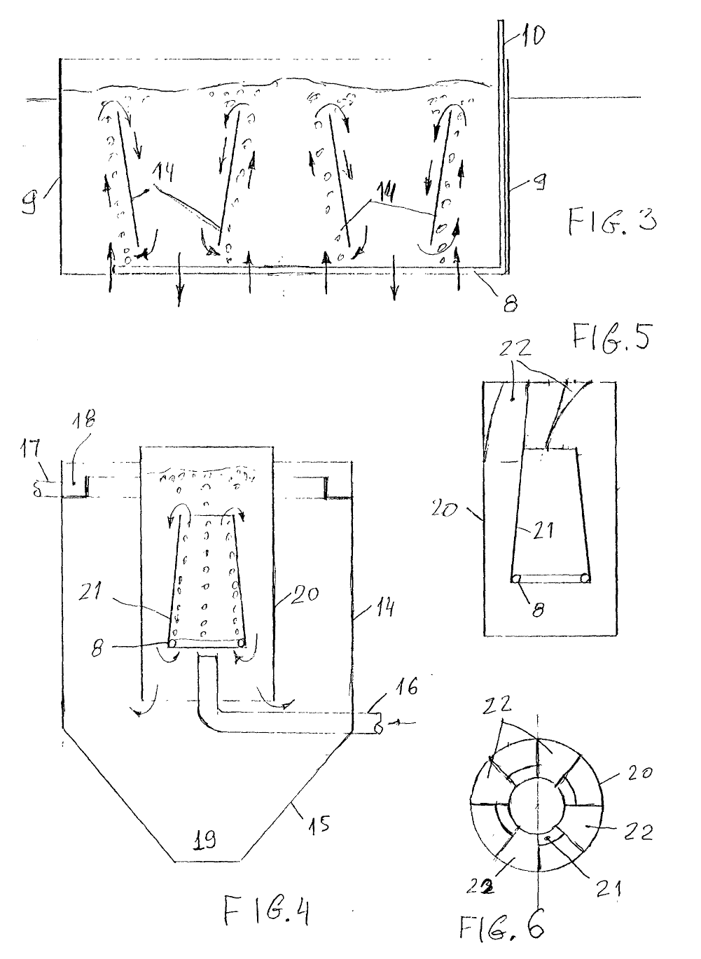

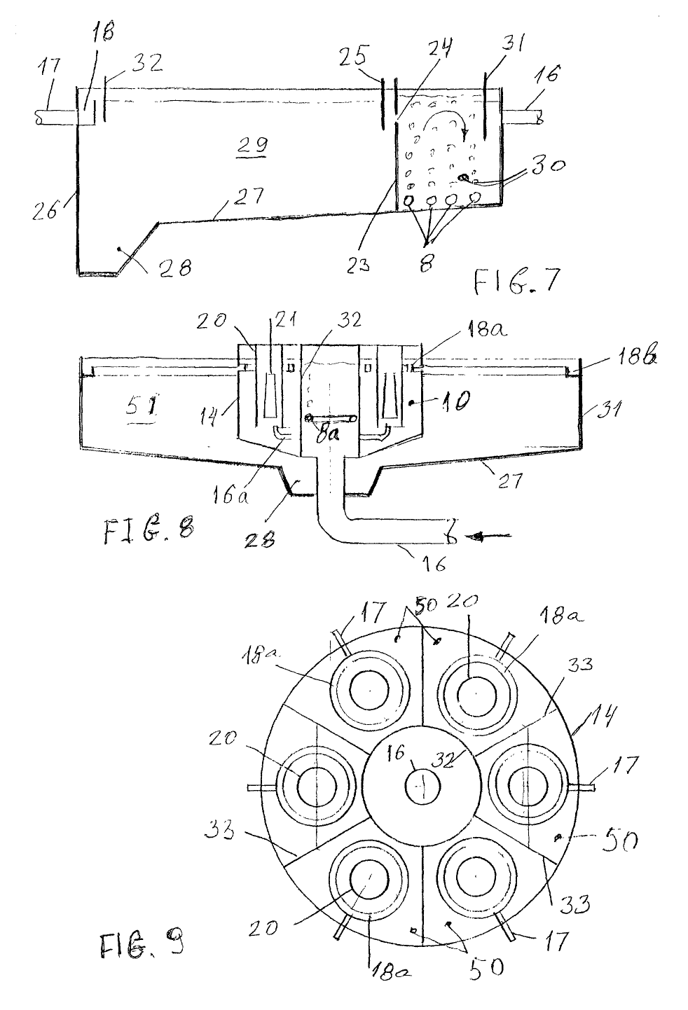

Referring now to FIG. 3, there is shown a stripping means similar to that of FIGS. 1 and 2 with the addition of circulation baffles 14. These baffles produce a more controllable pattern of ascending and descending flows in the stripper. Well pronounced descending flows will be the streams of a heavier biomass more rapidly exiting the slot 4. The embodiment of FIG. 3 can be operated with swinging, rocking, mixing, and jolting actions as previously described.

Referring now to FIG. 4, there is shown an upflow clarifier with a circular, or polygonal, or square, outer wall 14 and an inverted conical or pyramidal wall 15 accommodating the sludge zone 19, a trough 18 at the top is provided for collecting the clarified wastewater, which is provided with a discharge pipe 17. A cylindrical, or polygonal body 20 without top or bottom accommodates the stripping means. An air distributor 8 is provided inside the body 20. A feed line 16 is provided for the mixed liquor. Optionally, a conical, or polygonal circulation baffle 21 is provided. Optionally, body 20 may have a top and a bottom with appropriate passages for mixed liquor and air.

The embodiment of FIG. 4 is operated as follows. The mixed liquor enters the stripping means via line 16 and carbon dioxide is stripped from it by feeding air via distributor 8. The chemical and physical-chemical transformations in the stripping means have already been described. The carbon dioxide free and calcium carbonate loaded biomass exits from the stripping device into the settling zone, sludge settles to the bottom and is evacuated by a pumping or lifting means (not shown). The clarified wastewater is collected in the trough 18 and evacuated via line 17. Conical baffle produces more controllable circulation patterns in the stripping means similarly to already described inclined baffles in the previous embodiment. Similarly to the previous embodiments, swinging, rocking, and jolting actions can also be produced.

Referring now to FIGS. 5 and 6, there is shown an alternative design of the stripping means with flow deflecting baffles 22 producing tangential flow at the top of the conical baffle. This rotational flow will extend to the bottom of the skirt 20 thus improving the uniformity of the liquid distribution entering the clarification zone.

Referring now to FIG. 7, there is shown a settling tank with predominantly horizontal flow of mixed liquor. The settling tank consists of side and end walls 26 and a slanted bottom 27. The influent line 16 and a semisubmerged baffle 31 are provided at the entrance to the tank and a collection trough 18 with a semisubmerged baffle 32 and an effluent line 17 are provided at the tank exit. A dividing wall 23 with openings 24 and a deflection baffle 25 are built in the tank volume. The wall 23 separates the settling zone 29 from the carbon dioxide stripping zone 30. Air distributors 8 are provided at the bottom of the stripping zone 30. A sludge collection zone 28 with a pipe for sludge evacuation (not shown) are also provided.

The embodiment of FIG. 7 is operated as follows. The mixed liquor enters the stripping zone 30 via line 16 and is aerated by the air supplied via distributors 8. After stripping carbon dioxide and effecting the reactions as previously described, the mixed liquor enters the settling zone 29, sludge becomes separated and evacuated via sludge zone and the clarified wastewater is evacuated via trough 18 and line 17. The chemical and physical-chemical transformations in the carbon dioxide stripper have already been discussed. It is understood that a dedicated stripping zone can be provided separately from clarifiers in a free-standing tank preceding the clarifier and functionally associated with the clarifier.

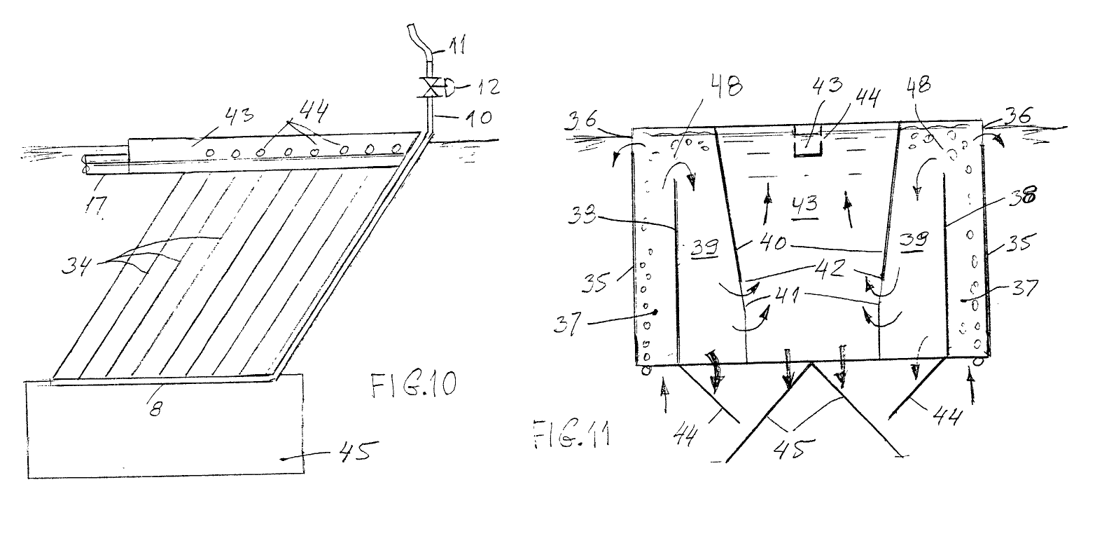

Referring now to FIGS. 8 and 9, there is shown a clarifier with predominately radial flow of mixed liquor. This clarifier consists of a circular, or square wall 31, a bottom 27 slanting to the sludge sump 28. The influent line 16 feeds into the central well used as a first step of carbon dioxide stripping, the well is delineated by a wall 32. This is a dedicated stripping zone which precedes the clarifier. In this embodiment, the central well is also the first stage stripping zone in a two sequential stages arrangement. This stripping zone is provided with an air distributor 8a. This zone is in a hydraulic communication via lines 16a with multiple stripping-presettling units (six is shown) each similar in design to the embodiment exemplified in FIGS. 4, 5, and 6. These units are in the hydraulic communication with the final separation stage 51.

The embodiment of FIGS. 8 and 9 is operated as follows. The influent enters the first stripping stage 32 and becomes at least partially sweetened, and is transferred to the multiple-section second stage where it is additionally sweetened and partially settled. The settled sludge is transferred via bottom openings (not shown) in the sections 50 in the sludge sump. The partially clarified wastewater is transferred via lines 17 in the final separation zone 51 and the settled sludge is pushed by a scarper mechanism (not shown) in the sludge sump 28, while the clarified water is collected in the trough 18 and evacuated. The chemical and physical-chemical transformations in this system are the same as previously discussed. The partially clarified wastewater carries little suspended solids and its density is not significantly different from the clarified water. Accordingly, the intensity of the density currents is substantially reduced.

Referring now to FIGS. 10 and 11, there is shown a lamella clarifier with carbon dioxide stripping zones. The clarifier is assembled from lamella plates 34 having two stripping zones 37, two downflow sludge separation zones 39, and a single upflow sludge separation zone 43. These zones are delineated by baffles 35, 38, 40, and 41. There are passages 36 above baffles 35 in the upper part of the lamella 34. There are passages 48 above baffles 38 in the upper part of the lamella 34. Baffles 41 continue baffles 40 but have a lesser height than the spacing between lamellas. A channel 43 with holes 44 are provided for collecting clarified water. A line 17 is for the evacuation of the clarified water. Air distributors 8 with pipes 10, valves 12, and optionally flexible connections 11 are provided in both stripping sections. Optionally, gas separating and deflecting baffles 44 and 45 are provided underneath the lamellar assembly. The lamellar assembly can be either fixed in a biological reactor or a vessel in a hydraulic communication with such reactor or it can be on floats. When using floats, a flexible connection to pipe 17 and flexible connections 11 should be used.

The embodiment of FIGS. 10 and 11 is operated as follows. Mixed liquor is driven into the stripping sections 37 by the airlift effect produced by air distributors 8. Carbon dioxide is substantially stripped in the stripping sections. At the top of the stripping sections, the flow of aerated mixed liquor is split between the passages 36 and 48. The flow via passages 48 is the design flow through the lamella clarifiers. A partial clarification occurs on the way down in sections 39 and the separated sludge portion is removed via bottom openings. A partially clarified wastewater flows over baffles 41 into section 43, undergoes final clarification and is collected via holes 44 into channel 43 and evacuated via line 17. Sludge separated in section 43 slides down and out via bottom openings between baffles 41. If gas bubbles are present in the mixed liquor below the lamella separator, they are deflected from the settling sections 39 and 43 by baffles 44 and 45. Constant air flow rate, On/Off, and variable flow operations, and their combinations can be used in the stripping sections. Accordingly, rocking, mixing, and jolting actions can be applied to the lamella separator similarly to that already described. The chemical and physical-chemical processes in the stripping sections of the lamella clarifier are the same as in the previous embodiments.

While the invention has been described in detail with the particular reference to preferred embodiments thereof, it will be understood that variations and modifications can be effected within the spirit and the scope of the invention as previously described and as defined by the claims. For example, gravity separators not described herein can also be upgraded with sweetening steps. Other separators can also be used, such as centrifuges where the gravity is “enhanced”. The presently illustrated gravity separators may have other physical provisions for conducting sweetening steps. It is also trivial that mechanical or many other known aerators can be used for the described sweetening.

I claim:

1. A method of separation of biomass and treated wastewater after biological processes, said biomass and said treated wastewater form mixed liquor, said separation produces separated biomass and separated treated wastewater, wherein a step of stripping carbon dioxide is provided, whereby said stripping is associated with said step of separating said mixed liquor into said biomass and said treated wastewater, and whereby said stripping sweetens said mixed liquor, said separated biomass, and said separated treated wastewater.

2. The method of claim 1, wherein said biological treatment is selected from a group consisting of oxygen-based aerobic treatment, air based aerobic treatment, anoxic treatment, sulfur reducing anaerobic treatment, ferric ions reducing anaerobic treatment, acidogenic anaerobic treatment, acetogenic anaerobic treatment, methanogenic anaerobic treatment, ferrous ions reducing anaerobic treatment, and combinations thereof.

3. The method of claim 1, wherein said method of separating biomass and treated wastewater is conducted in separation means selected from a group consisting of settling tanks, clarifiers, settling tanks with Imhoff troughs, settling tanks with upflow of said mixed liquor, settling tanks with horizontal flow of said mixed liquor, settling tanks with a radial flow of said mixed liquor, conical separators, vortex separators, lamellar separators, clarifiers with rigid packing, clarifiers with flexible packing, centrifuges, and combinations thereof.

4. The method of claim 1, wherein said stripping step is selected from the group consisting of air stripping, inert gas stripping, vacuum-stripping, thermal stripping, and combinations thereof.

5. The method of claim 1 and further providing a step of providing at least one recuperable alkaline specie.

6. The method of claim 5, wherein said recuperable alkaline species are selected from the group consisting of calcium, iron, and combinations thereof.

7. The method of claim 1 and further providing a step of charging at least one recuperable oxidation-reduction specie.

8. The method of claim 7, wherein said at least one recuperable oxidation-reduction specie is a transitional element.

9. The method of claim 8, wherein said transitional elements are selected from the group comprising vanadium, chromium, manganese, iron, cobalt, nickel, and combinations thereof.

10. The method of claim 4, wherein said air stripping is selected from the mode of continuous stripping, on/off stripping, stripping with variable air flow rates, and combinations thereof.

11. The method of claim 4, wherein said air stripping induces mechanical action upon said mixed liquor, said mechnical action being selected from the group consisting of mixing, rocking, inducing vortex, jolting, and combinations thereof.

12. The method of claim 4, wherein said air stripping is provided by multiple air distributors, operating mode of said multiple distributors is selected from simultaneous operation, on/off operation of at least one of said distributors, variable air flow operation of at least one of said distributors, and combinations thereof.

13. The method of claim 3, wherein a step of air stripping of said carbon dioxide is provided in said separation means, whereby said step of air stripping is conducted using at least one air distributor.

14. The method of claim 13 wherein said step of air stripping of carbon dioxide is provided in air stripping means selected from the group of rigidly supported stripping means and floating stripping means.

15. The method of claim 13 wherein said air stripping is conducted with stripping means selected from the group of non-enclosed air strippers, enclosed air strippers, and combinations thereof.

16. The method of claim 13 and further providing means for circulating said mixed liquor and/or said biomass being sweetened.

17. The method of claim 16, wherein said circulating is induced by means selected from the group consisting of air used for said stripping, inclined baffles, tangential flow directors, and combinations thereof.

18. The method of claim 1, wherein said separation of biomass and treated wastewater is conducted in separation means selected from the group of rigidly supported separation means, and floating separation means.

19. The method off claim 1, wherein said step of stripping is conducted in multiple stages, said multiple stages are vselected from the group of sequential stages, parallel stages, and combinations thereof.

20. The method of claim 1, wherein a step of feeding alkali metal ions is provided, whereby said alkali metal ions are fed in forms selected from the group of metal hydroxides, salts of weak acids, salts of biologically consumable acids, alkali containing biologically consumable compounds, and combinations thereof
